(19) United States
(12) Patent Application Publication
(10) Pub. No.: US 2023/0337630 A1
(43) Pub. Date: Oct. 26, 2023

(54) SYSTEMS AND METHODS OF INDIVIDUAL ANIMAL IDENTIFICATION

(71) Applicant: 406 Bovine, Inc., Katy, TX (US)

(72) Inventors: Bryan R. Elliott, Katy, TX (US); Shreyas Gite, Potsdam (DE)

(21) Appl. No.: 18/132,495

(22) Filed: Apr. 10, 2023

Related U.S. Application Data
(60) Provisional application No. 63/333,812, filed on Apr. 22, 2022.

(51) Int. Cl. A01K 11/00; G06V 40/10

(52) U.S. Cl. CPC A01K 11/006; G06V 40/10

(57) ABSTRACT

An animal identification system accepts images, determines if animal faces exist in the images, then transforms those animal faces to permit comparison with known animal faces. The comparison process uses vectorized data to determine the similarity between known and unknown animal faces using, in some embodiments, a distance or difference function calculated on or among vectorized data. The system allows capture of known animal faces and addition of those known animal faces to the stored known animal faces in in the system without retraining the comparison algorithm. The system improves over time, in part, from user feedback.

### RELATED APPLICATIONS

This application claims priority to and the benefit of U.S. Provisional Patent Application No. 63/333,812, filed Apr. 22, 2022, which is incorporated herein by reference in its entirety for all purposes.

### BACKGROUND

Individuals in the animal raising and processing businesses desire more efficient ways to uniquely identify and track individual animals over time. Existing methods for doing such processes involve ear tags, which are non-standard across producers and processors and thus non-unique in identifying animals. Other methods include embedding of micro chips or RFID tags but these methods are expensive and again, non-unique across producers and processors.

### SUMMARY

The disclosure provides, in one aspect, an animal identification method comprising: an animal registration phase including: capturing with a device at least one image of a first known animal; determining a first data vector based on the at least one image of the first known animal with a model; receiving on the device a first set of identifying information of the first known animal; and saving the first data vector and the first set of identifying information for the first known animal to a database. The animal registration phase further includes capturing with the device at least one image of a second known animal; determining a second data vector based on the at least one image of the second known animal with the model; receiving on the device a second set of identifying information of the second known animal; and saving the second data vector and the second set of identifying information for the second known animal to the database. The animal identification method further comprises an animal identifying phase including: capturing with the device at least one image of an unidentified animal; determining a new data vector based on the at least one image of the unidentified animal with the model; comparing the new data vector to the first data vector and the second data vector, and identifying the unidentified animal as the first known animal or the second known animal; and displaying on the device the identified animal including the corresponding set of identifying information.

In some embodiments, capturing at least one image of the first known animal comprises capturing a first image of the first known animal at a first perspective and a second image of a first known animal at a second perspective.

In some embodiments, capturing at least one image of the first known animal comprises capturing a video of the first known animal.

In some embodiments, the animal identifying phase further includes receiving feedback on the device regarding the accuracy of identifying the unidentified animal as the identified animal.

In some embodiments, the animal is a cow, a sheep, a horse, a pig, a goat, a chicken, a dog, or a cat.

In some embodiments, the first set of identifying information includes an ear tag, a lot ID, a sex, a note, a feed performance, a lameness, a sickness, an antibiotic status, a pen movement, or any combination thereof.

In some embodiments, the model is a machine learning model.

In some embodiments, the model is trained with a set of augmented data.

In some embodiments, the set of augmented data includes a rotated image, a scaled image, a flipped image, a brightness adjusted image, a generative image, or any combination thereof.

The disclosure provides, in one aspect, an individual animal identification system comprising: an image capturing device able to capture at least one digital image; a communication channel connected to the image capturing device; and a computer connected to the communication channel. The computer includes at least one processor and a non-transitory computer readable memory. The image capturing device captures the at least one digital image and transmits the at least one digital image using the communication channel to the computer causing the computer to: detect the presence of an animal face in the at least one digital image transmitted from the image capturing device; determine and store the coordinates of a location of the detected face of an animal in the at least one digital image; apply at least one transformation of the detected animal face in the at least one digital image creating at least one transformed digital image; compare the at least one transformed digital image to at least one stored digital image using a concurrent vector comparison to calculate a degree of similarity between the at least one transformed digital image and the at least one stored digital image; transmit the calculated degree of similarity to the image capturing device using the communication channel; receive feedback as to the accuracy of the calculated degree of similarity between the at least one transformed digital image and the at least one stored digital image; and update the concurrent vector comparison calculation to improve accuracy.

In some embodiments, the image capturing device captures data including three-dimensional orientation of the object in the digital image.

In some embodiments, the image capturing device captures data including a depth of an object in the digital image.

In some embodiments, detecting the presence of an animal face in the at least one digital image transmitted from the image capturing device includes detecting key points in the image, including the eyes, muzzle, ears, mouth, and other known facial features of the animal.

In some embodiments, detecting the presence of an animal face in the at least one digital image transmitted from the image capturing device includes detecting a depth of the animal.

In some embodiments, the concurrent vector comparison uses vectors of values to compare multiple values in different vectors simultaneously, which may be comprised of a triplet loss technique where a reference input image is compared to a matching input image and a non-matching input image to minimize the difference between the reference input image and the matching input image and maximize the distance between reference input image and the non-matching input image.

In some embodiments, the at least one transformation of the detected animal face in the digital image includes at least one of cropping to eliminate non-facial data, orienting the detected animal face for standard analysis and comparison, scaling the image of the detected animal face to standard size, detecting standard facial features such as distance between eyes, and deriving at least one vector of image data from the detected animal face.

In some embodiments, the at least one digital image may be a series of digital images comprising a video image.

In some embodiments, the concurrent vector comparison utilizes a comparison algorithm calculating the difference between different animal faces and using that difference calculation can select a stored image similar to the at least one transmitted image or indicate no similar image exists in non-transitory memory.

Other aspects of the disclosure will become apparent by consideration of the detailed description and accompanying drawings.

### BRIEF DESCRIPTION OF THE DRAWINGS

The foregoing aspects and other features of the Animal Identification System are explained in the following description, taken in connection with the accompanying drawings, herein.

FIG. 1 is a schematic illustrating an animal identification system for individual animal identification.

FIG. 2 is a flow chart illustrating a method of registering a known animal.

FIG. 3 is a flow chart illustrating a method of identifying an unidentified animal.

FIG. 4 is an image of an animal illustrating detection of an animal face and cropping of data outside the box shown.

FIG. 5 illustrates an example of comparison data vectors being generated and used to determine positive matches and negative matches.

FIG. 6 illustrates how comparison criteria is improved using feedback to more clearly delineate images that match from those non-matching images.

FIG. 7 is a flow chart of a method for adding known animals to a database.

FIG. 8 is a flow chart of a method of identifying an unidentified animal.

FIG. 9 is a flow chart of a method including an animal registration phase and an animal identifying phase.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Section headings as used in this section and the entire disclosure herein are merely for organizational purposes and are not intended to be limiting.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not. Further, unless otherwise required by context, singular terms shall include pluralities and plural terms shall include the singular.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated. Recitation of ranges of values herein are merely intended to serve as a shorthand method of referring individually to each separate value falling within the range, unless otherwise-Indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

As used herein, the terms “processor” and “central processing unit” or “CPU” are used interchangeably and refer to a device that is able to read a program from a computer memory (e.g., ROM or other computer memory) and perform a set of steps according to the program. As used herein, the term “processor” (e.g., a microprocessor, a microcontroller, a processing unit, or other suitable programmable device) can include, among other things, a control unit, an arithmetic logic unit (“ALC”), and a plurality of registers, and can be implemented using a known computer architecture (e.g., a modified Harvard architecture, a von Neumann architecture, etc.). In some embodiments the processor is a microprocessor that can be configured to communicate in a stand-alone and/or a distributed environment, and can be configured to communicate via wired or wireless communications with other processors, where such one or more processor can be configured to operate on one or more processor-controlled devices that can be similar or different devices.

As used herein, the term “memory” is any memory storage and is a non-transitory computer readable medium. The memory can include, for example, a program storage area and the data storage area. The program storage area and the data storage area can include combinations of different types of memory, such as a ROM, a RAM (e.g., DRAM, SDRAM, etc.), EEPROM, flash memory, a hard disk, a SD card, or other suitable magnetic, optical, physical, or electronic memory devices. The processor can be connected to the memory and execute software instructions that are capable of being stored in a RAM of the memory (e.g., during execution), a ROM of the memory (e.g., on a generally permanent bases), or another non-transitory computer readable medium such as another memory or a disc. In some embodiments, the memory includes one or more processor-readable and accessible memory elements and/or components that can be internal to the processor-controlled device, external to the processor-controlled device, and can be accessed via a wired or wireless network. Software included in the implementation of the methods disclosed herein can be stored in the memory. The software includes, for example, firmware, one or more applications, program data, filters, rules, one or more program modules, and other executable instructions. For example, the processor can be configured to retrieve from the memory and execute, among other things, instructions related to the processes and methods described herein.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks, whether local or distant (e.g., cloud-based).

“About” and “approximately” are used to provide flexibility to a numerical range endpoint by providing that a given value may be “slightly above” or “slightly below” the endpoint without affecting the desired result.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

As used herein, the term “in electronic communication” refers to electrical devices (e.g., computers, processors, etc.) that are configured to communicate with one another through direct or indirect signaling. Likewise, a computer configured to transmit (e.g., through cables, wires, infrared signals, telephone lines, airwaves, etc.) information to another computer or device, is in electronic communication with the other computer or device. As used herein, the term “transmitting” refers to the movement of information (e.g., data) from one location to another (e.g., from one device to another) using any suitable means.

As used herein, the term “network” generally refers to any suitable electronic network including, but not limited to, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some embodiments, the network is a cellular network, such as, for example, a Global System for Mobile Communications (“GSM”) network, a General Packet Radio Service (“GPRS”) network, an Evolution-Data Optimized (“EV-DO”) network, an Enhanced Data Rates for GSM Evolution (“EDGE”) network, a 3GSM network, a 4GSM network, a 5G New Radio, a Digital Enhanced Cordless Telecommunications (“DECT”) network, a digital AMPS (“IS-136/TDMA”) network, or an Integrated Digital Enhanced Network (“iDEN”) network, etc.

As used herein, the term “animal” refers to any animal (e.g., a mammal, a reptile, a bird, an amphibian, a fish), including, but not limited to, beef cattle, dairy cattle, horses, pigs, sheep, goats, chickens, ducks, turkeys, cows, dogs, cats, non-human primates, livestock, equines, and the like.

As used here, the term “known animal” refers to an animal that is known to a user or identifiable by the user such that the user is able to provide further information regarding the animal.

### 2. Animal Identification System

An animal identification system described herein provides a unique and inexpensive system and method for capturing data about an animal, identifying the animal from that data, and then identifying and tracking the animal over time, across locations, and under different conditions. As all humans have unique fingerprints, humans and animals have unique facial features that once captured can be used to identify individuals. Rather than attaching, detaching, and reattaching new ear tags, or incurring the time and cost intensive process of inserting micro chips or RFID chips, facial recognition can be quickly captured, stored electronically, and used by producers and processors across geographical regions and over time. In addition, animals are not subject to privacy restrictions associated with humans making identifying technology more powerful, more widely useable, and more open to use by multiple parties than human facial recognition may ever be.

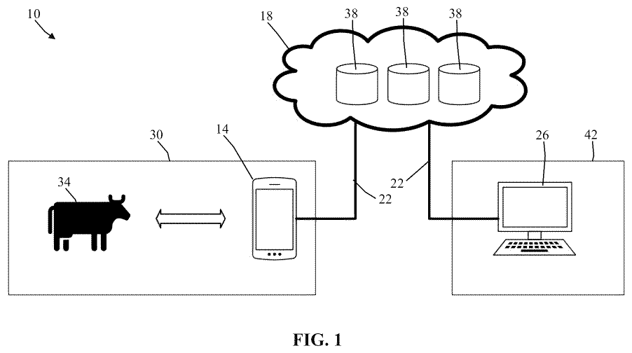

With reference to FIG. 1, an individual animal identification system 10 includes a device 14, a network 18 including a communication channel 22, and a computer 26. In some embodiments, the communication channel 22 is wired. In other embodiments, the communication channel 22 is wireless.

In the illustrated embodiment, the device 14 is an image capturing device able to capture at least one digital image. In some embodiments, the device 14 can capture a video. In some embodiments, the device 14 can capture data including a three-dimensional orientation of an object in the digital image. In some embodiments, the device 14 can capture data including a depth of an object in the digital image. In some embodiments, the device 14 is a user device such as a cellular phone, a tablet, a personal computer, or any other suitable user device. In the illustrated embodiment, the user device 14 is a cellular phone with a display.

In the illustrated embodiment, the device 14 is located on or near a user in a first location 30. In some embodiments, the first location 30 is a wherever the user is located and moves with the user. As explained in greater detail herein, in some embodiments, the device 14 is configured to capture an image of an animal 34 at the first location 30.

With continued reference to FIG. 1, a communication channel 22 is connected to the image capturing device 14. In some embodiments, the network 18 is a cloud-based network connected to the internet. In some embodiments, the network 18 includes a plurality of databases 38 for the storage of various data disclosed herein. In some embodiments, data collected from the image capturing device 14 is stored in the database 38. In some embodiment, the databases 38 include information collected from a plurality of users.

In the illustrated embodiment, data on the device 14 is transmitted via the communication channel 22 (e.g., via WiFi) to the network 18 and stored in databases 38. In some embodiments, data flow bidirectionally between the device 14 and the network 18. In other words, the device 14 can send data to the network 18, and the network 18 can send data to the device 14. In the illustrated embodiment, the image capturing device 14 captures at least one digital image and transmits the at least one digital image using the communication channel 22 to the computer 26.

In some embodiments, the computer 26 is a mobile phone, a tablet, etc. connected to the network 18. In the illustrated embodiment, the computer 26 is connected to the communication channel 22. The computer 26 includes at least one processor and a non-transitory computer readable memory. In some embodiments, the computer 26 can be any suitable network connected device that enables access and manipulation of the databases 38. In the illustrated embodiment, the computer 26 is located at a second location 42. In some embodiments, the second location 42 is spaced from or remote from the first location 30. For example, the first location 30 may be a pasture or feed lot and the second location 42 may be an office or a server room. Both the first location 30 and the second location 42 are connected to the network 18.

As detailed further herein, the animal identification system 10 is a system wherein the image capturing device 14 (e.g., a phone, a digital camera with wifi communication ability, a tablet, or the like) is used to capture at least one image or in some embodiments videos of an animal. The image capturing device 14 transmits the at least one image across the communication channel 22 (e.g., wired, or Bluetooth or WIFI) to an internet connection wherein the communication channel continues across the internet to the computer 26 with at least one processor and non-transitory memory, such as a hard drive, where the at least one image is stored, processed, and utilized. The system 10 provides integrated data storage, calculation, and comparison of images of animals that can be used generically across all animal types for identification of animals. As detailed further herein, the registration and identification of animals by the system 10 provides a means for herd management, health monitoring, and productivity assessment.

### 3. Data Processing and Augmentation

Data collected by the device 14 can include an image, a plurality of images, a video, user input data, or any combination thereof. The data from the device 14 is transmitted via the communication channel 22 to the database 38 on the network 18. The saved data may then be processed, transformed, and augmented, as disclosed herein.

In some embodiments, the computer 26, using stored instructions, performs one or more transformations on the image or images transmitted from the image capturing device. Such transformations, in some embodiments, include detecting an animal face, cropping non-facial data from the at least one image to eliminate extraneous data, re-orienting the detected animal face in the at least one image to a standard position within the image, re-sizing the face to normalize calculations and feature detection, dithering and smoothing, or other such image transformations.

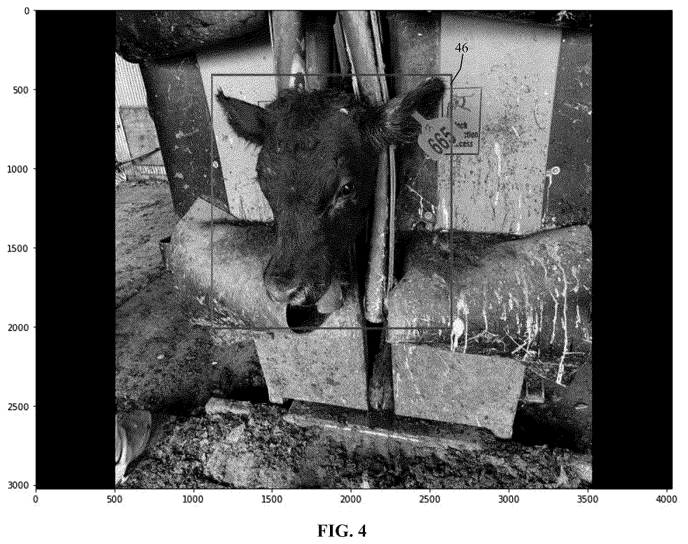

In one example, the computer 26 executes stored instructions to detect the presence of an animal face in the digital image transmitted from the image capturing device 14. This processing may occur whether the animal face is a known animal face or is an unidentified animal face. With reference to FIG. 4, an animal face is detected in an image and an area of containing the animal face is delineated with a bounding box 46. Portions of the image outside of the bounding box 46 may be cropped or eliminated from further processing, transformation, or comparison. In some embodiments, detecting the presence of an animal face in the digital image from the device 14 includes detecting key points in the image including, but not limited to, eyes, muzzle, ears, mouth, or other known facial features of the animal. In some embodiments, detecting the presence of an animal face in the digital image from the device 14 includes detecting a depth of the animal.

In one example, the computer 26 executes stored instructions to determine and store the coordinates of a location of the detected face of an animal in the digital image.

In one example, the computer 26 executes stored instructions to apply at least one transformation of the detected animal face in that digital image to create at least one transformed digital image.

In some embodiments, the computer 26, using stored instructions, performs one or more calculations on the transformed image, including, in some embodiments, producing a one or more vectors of data and calculated data from the transmitted image which can be used to compare to one or more vectors of data and calculated data from images stored in non-transitory member. As detailed further herein, such comparison, in some embodiments, may use a comparison technique wherein a known image is compared to one of more of the transmitted images to determine a match, the comparison technique may be a triplet derived comparison, a neural network, a heuristic approach, or a stochastic or deterministic model, among other artificial intelligence techniques. The comparison technique may produce a difference value or values which can be used to determine the similarity between two or more images, or indicate no such similarity between images exists.

In some embodiments, the transformation of the detected animal face in the digital image includes at least one of cropping to eliminate non-facial data, orienting the detected animal face for standard analysis and comparison, scaling the image of the detected animal face to standard size, detecting standard facial features such as distance between eyes, and deriving at least one vector of image data from the detected animal face.

In some embodiments, the image data received from the device 14 is augmented to improve the system 10 performance. In some embodiments, generative models are used for data augmentation. In some embodiments, generative models create synthetic data and are applied to generate training data. Data augmentation is important and helpful when limited training data exists. For example, unlike images of human faces where there is adequate training data available from various sources (e.g., the internet), there is limited training data for images of beef and dairy cattle faces. Data augmentation disclosed herein advantageously bolsters the training data available to train various models on various animal faces. In some embodiments, generative models create synthetic data that is then applied as training data for tasks such as bounding box annotation, segmentation, and animal face identification.

Data augmentation is a technique for enhancing the performance of a model (e.g., a machine learning model), especially in image-based tasks with limited training data. Data augmentation is a technique used to artificially increase the size and diversity of a dataset by applying various transformations to the original data. In an image-based task, data augmentation techniques include rotation, scaling, flipping, brightness adjustments, and other suitable image transformations. Data augmentation improves the capability of the model to generalize by providing more varied training examples, which reduces overfitting problems.

Generative models are a class of machine learning models that can generate new data instances by learning the underlying distribution of the input data. In other words, generative models can create synthetic data for data augmentation. In one embodiment, the generative models are Generative Adversarial Networks (GANs). GANs include two neural networks, a generator, and a discriminator that are trained simultaneously. The generator learns to create realistic synthetic images, while the discriminator learns to distinguish between real and generated images. As another example, the generative models are Variational Autoencoders (VAEs), which are a type of autoencoder that learns to encode input data into a lower-dimensional latent space and then decode it back into the original data form. The VAE is trained to learn the distribution of the input data in the latent space, enabling it to generate new data instances.

In one embodiment, generative models are used to improve the bounding box annotation task. For example, GANS and VAEs can be used to generate synthetic images of cattle with associated bounding box annotations. By training the generative model on images of cattle with their corresponding bounding boxes, the model can learn to generate new images with realistic object locations and sizes. The synthetic images and their associated bounding boxes can then be used to augment the training dataset, which improves the performance of the face identifying model for cattle faces.

In one embodiment, generative models are used to improve the segmentation task. For example, generative models can be applied to create synthetic images with corresponding segmentation masks. By training the model on images of cattle and their associated segmentation masks, for example, the generative model can generate new images with realistic segmentations. These synthetic images are used to augment the training data for the face identifying model, which enhances the ability to identify the region of interest (ROI) accurately.

In one embodiment, generative models are used to improve the face identifying models. For example, generative models can be employed to generate diverse and realistic images of cattle faces, capturing variations in pose, lighting, and background. These synthetic images can be utilized to augment the training dataset for the face identifying model, thereby improving the ability of the model to identify individual cattle accurately. By providing a more diverse and representative training dataset, the face identification model achieves better generalization and performance in real-world scenarios.

As such, generative models (e.g., GANs, VAEs, etc.) provide a data augmentation approach for developing face identification solutions for animals. By generating synthetic images with, for example, bounding box annotations, segmentation masks, and diverse cattle faces, the generative models improve the overall performance of the system 10. Integration of data augmentation into the data pipeline significantly enhances the generalization capability of the model, which leads to more accurate and robust identification of the animal in various conditions.

In some embodiments, improved generative models are utilized, which provide higher-quality synthetic data that better mimics real-world variability. In some embodiments, domain adaptation is utilized. The use of domain adaptation techniques helps transfer knowledge from the synthetic data to the real-world data, further improving the performance of the system 10. In some embodiments, multi-modal data augmentation is utilized. For example, the use of generative models for multi-modal data augmentation, such as combining visual and depth information, can enhance the ability of the system 10 to handle complex scenarios. In some embodiments, evaluation metrics and methodologies are developed to quantify the impact of generative model-based data augmentation on the performance of the system 10. The use of generative models for data augmentation in animal face identification systems provides a more effective and efficient identification system.

### 4. Model and Comparison

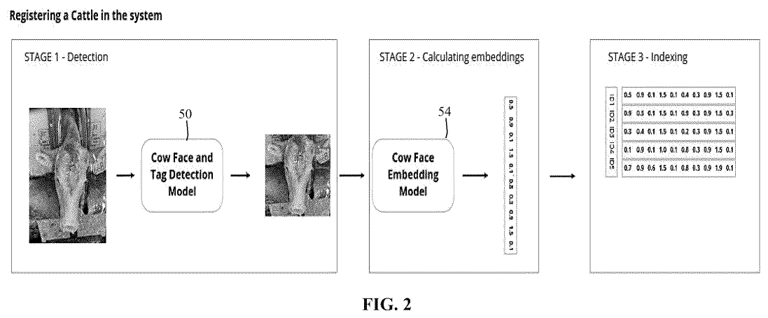

In some embodiments, the system 10 utilizes one or more machine learning models. For example, in one embodiment, a first model is trained to detect a face and/or tag of an animal (e.g., cow face and tag detection model 50 of FIG. 2), and a second model is trained to calculate unique vector data for an animal face (e.g., cow face embedding model 54 of FIG. 2). In some embodiments, at least one machine learning model transforms an image of an animal into a data vector, which can then be saved on the database or used for comparison to other data vectors to assess similarities. In some embodiments, the comparison of data vectors includes determining a distance score between two data vectors.

In one example, the computer 26 executes stored instructions to compare the transformed digital image to the stored digital images using a concurrent vector comparison. In some embodiment, the concurrent vector comparison calculates a degree of similarity between the transformed digital image and the stored digital images.

In some embodiments, the concurrent vector comparison uses vectors of values to compare multiple values in different vectors simultaneously, which may be comprised of a triplet loss technique where a reference input image is compared to a matching input image and a non-matching input image to minimize the difference between the reference input image and the matching input image and maximize the distance between reference input image and the non-matching input image.

In some embodiments, the concurrent vector comparison utilizes a comparison algorithm calculating the difference between different animal faces and using that difference calculation can select a stored image similar to the at least one transmitted image or indicate no similar image exists in non-transitory memory.

In one example, the computer 26 executes stored instructions to transmit the calculated degree of similarity to the image capturing device 14 using the communication channel 22.

In some embodiments, feedback (e.g., user feedback) is utilized to improve the accuracy of the models and improve the performance of the system 10. In one embodiment, the system 10 receives feedback on the accuracy of the identification of a transmitted image as similar to a stored image. In one example, the computer 26 executes stored instructions to receive feedback as to the accuracy of the calculated degree of similarity between the at least one transformed digital image and the at least one stored digital image.

In such cases, the comparison algorithm will be updated to improve the calculations, adjust the transformations, or, for example, adjust the randomness of a stochastic model or the margin treatment quantified by the slack variable used in triplet methods. In general, in some embodiments, improvements in comparison of images and therefore the accuracy of recognizing animal faces is improved with feedback. As one example, the computer 26 executes stored instructions to update the concurrent vector comparison calculation to improve accuracy.

### 5. Animal Registration

In one embodiment, with reference to FIG. 2, a user enters (e.g., registers) a known animal face into the system 10. After being registered, the known animal face can be used later to identify unidentified animals. Stage 1 processes an image of an animal with the detection model 50. Stage 2 processes the detected face with an embedding model 54, which represents the image as vectorized data. In other words, the entered known animal is processed and/or transformed to create a data vector that is stored for later comparison. In other words, the vectorized data of the image of the known animal is utilized later for comparison.

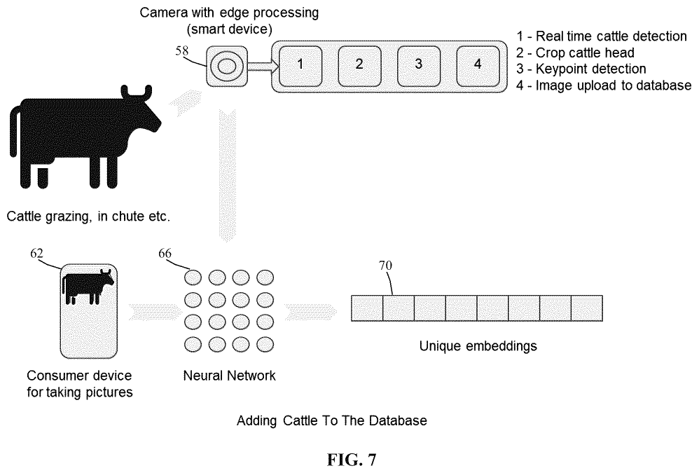

With reference to FIG. 7, an animal registration phase uses a camera 58 captures an image of an animal (e.g., cattle) in a chute or grazing in a pasture or feed lot, for example. In some embodiments, the camera 58 is a smart device with edge processing that is configured for real-time animal detection, cropping an animal head, key point detection, and image upload. In some embodiments, the camera 58 is integrated with an animal retaining mechanism, such as a chute. In some embodiments, the camera 58 is movable with respect to the animal retaining mechanism such that the camera 58 is able to capturing images of an animal at different perspectives. The animal registration phase may also use a user device 62 capable of capturing images of the animal. The camera 58 and/or the user device 62 provide input data to a model 66 (e.g., a neural network), which provides a unique embedding 70 of vectorized data to represent the known animal.

### 6. Animal Identification

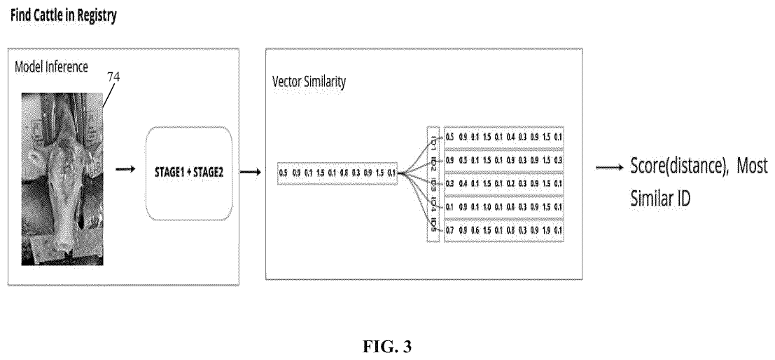

In one embodiment, with reference to FIG. 3, an image of an unidentified animal 74 enters the system is processed by a first model (“Stage 1”) trained to detect a face and/or tag of an animal (e.g., cow face and tag detection model 50 of FIG. 2), and a second model (“Stage 2”) trained to calculate unique vector data for an animal face (e.g., cow face embedding model 52 of FIG. 2). Animal faces in images are then compared using vectors of data to identify a positive match versus a negative match.

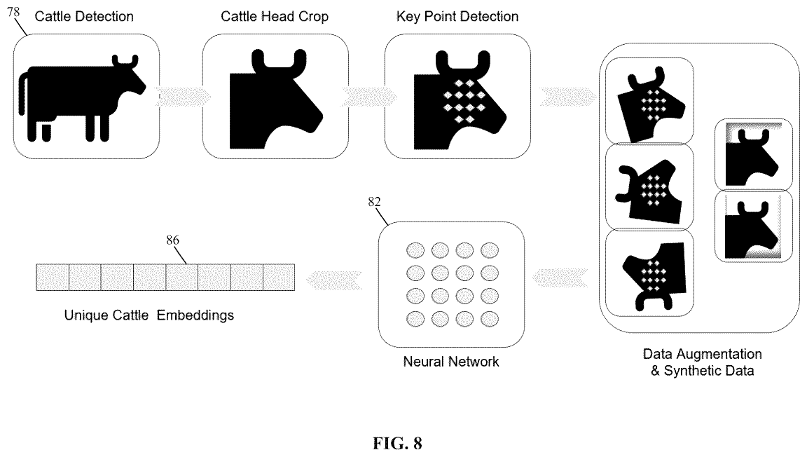

In one embodiment, with reference to FIG. 8, an image 78 of an unidentified animal are cropped, augmented, and key points identified. In the illustrated embodiment, the augmentation includes rotation and brightness adjustment, for example. The key points and augmented data are used as input to a neural network model 82 that determines a unique animal embedding of vectorized data 86 for the unidentified animal in the image.

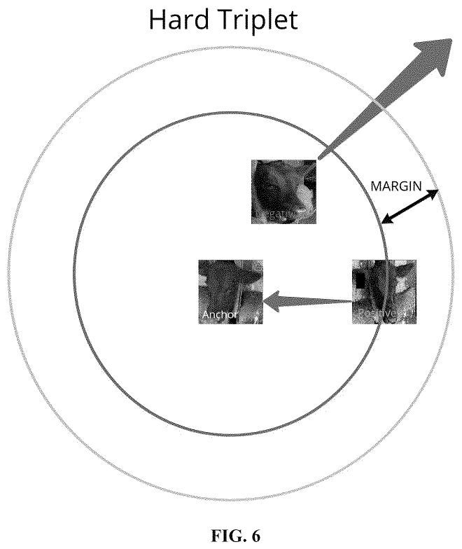

With reference to FIG. 6, a comparison of images makes the distance, or difference, between the images greater for negative matches and lessor for positive matches. Such distance, or difference, in some embodiments, may be within a margin of error.

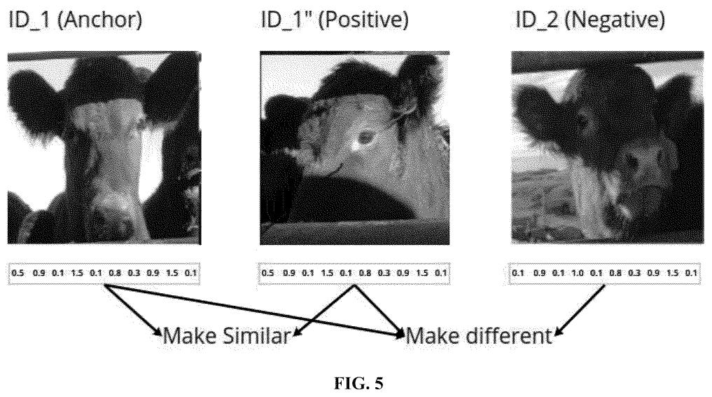

Results of the identification are used to improve, for example, the embedding model. In some embodiments, the system uses results to further improve identification by adjusting the distance, or difference, tolerances in vector data comparison, where such distances may be individual differences or summation of differences over compared data. With reference to FIG. 5, the vectorized data for positive matches are made more similar and the vectorized data for negative matches are made more different.

### 7. Methods and Systems

As disclosed herein, the system 10 provide for collection of information for known animals and identification of unknown animals.

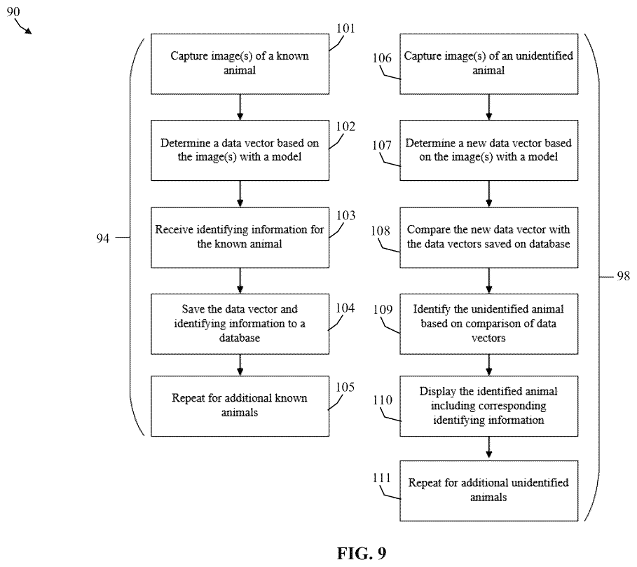

With reference to FIG. 9, an animal identification method 90 includes an animal registration phase 94 and an animal identifying phase 98. In some embodiments, the registration phase 94 is completed before the animal identifying phase 98. In other embodiments, the animal identifying phase 98 is performed after some, but not all of the animal registration phase 94 is complete.

In one embodiment, the animal registration phase 94 includes: (STEP 101) capturing with a device at least one image of a first known animal. In some embodiments, capturing at least one image of the first known animal comprises capturing a first image of the first known animal at a first perspective and a second image of a first known animal at a second perspective (e.g., multiple images and different perspectives). In some embodiments, capturing at least one image of the first known animal comprises capturing a video of the first known animal.

The animal registration phase 94 further includes (STEP 102) determining a first data vector based on the at least one image of the first known animal with a model. In some embodiments, the model is a machine learning model. In some embodiments, the model is trained with a set of augmented data (e.g., generative data, synthetic data, etc.). In some embodiments, the set of augmented data includes a rotated image, a scaled image, a flipped image, a brightness adjusted image, a generative image, or any combination thereof.

The animal registration phase 94 further includes (STEP 103) receiving on the device a first set of identifying information of the first known animal. In some embodiments, the set of identifying information includes an ear tag, a lot ID, a sex, a note, a feed performance, a lameness, a sickness, a antibiotic status, a pen movement, or any combination thereof. In some embodiments, the set of identifying information is entered by the user on the same device used to capture the image of the animal.

The animal registration phase 94 further includes (STEP 104) saving the first data vector and the first set of identifying information for the first known animal to a database. The animal registration phase 94 continues and repeats at (STEP 105) for additional known animals. For example, the animal registration phase 94 further includes capturing with the device at least one image of a second known animal, determining a second data vector based on the at least one image of the second known animal with the model, receiving on the device a second set of identifying information of the second known animal, and saving the second data vector and the second set of identifying information for the second known animal to the database.

In one embodiment, the animal identifying phase 98 includes: (STEP 106) capturing with the device at least one image of an unidentified animal; (STEP 107) determining a new data vector based on the at least one image of the unidentified animal with the model; (STEP 108) comparing the new data vector to the first data vector and the second data vector; and (STEP 109) identifying the unidentified animal as one of the animals registered in the animal registration phase 94 (e.g., the first known animal, the second known animal, etc.). In some embodiments, the animal identifying phase 98 further includes (STEP 110) displaying on the device the identified animal including the corresponding set of identifying information. In some embodiments, the animal identifying phase 98 further includes receiving feedback on the device regarding the accuracy of identifying the unidentified animal as the identified animal. The animal identifying phase 98 continues and repeats at (STEP 111) for additional unidentified animals.

Various changes and modifications to the disclosed embodiments will be apparent to those skilled in the art.

What is claimed is:

1. An animal identification method comprising:
an animal registration phase including:
capturing with a device at least one image of a first known animal,
determining a first data vector based on the at least one image of the first known animal with a model,
receiving on the device a first set of identifying information of the first known animal,
saving the first data vector and the first set of identifying information for the first known animal to a database,
capturing with the device at least one image of a second known animal,
determining a second data vector based on the at least one image of the second known animal with the model,
receiving on the device a second set of identifying information of the second known animal, and
saving the second data vector and the second set of identifying information for the second known animal to the database; and
an animal identifying phase including:
capturing with the device at least one image of an unidentified animal,
determining a new data vector based on the at least one image of the unidentified animal with the model,
comparing the new data vector to the first data vector and the second data vector, and identifying the unidentified animal as the first known animal or the second known animal, and
displaying on the device the identified animal including the corresponding set of identifying information.

2. The method of claim 1, wherein capturing at least one image of the first known animal comprises capturing a first image of the first known animal at a first perspective and a second image of a first known animal at a second perspective.

3. The method of claim 1, wherein capturing at least one image of the first known animal comprises capturing a video of the first known animal.

4. The method of claim 1, wherein the animal identifying phase further includes receiving feedback on the device regarding the accuracy of identifying the unidentified animal as the identified animal.

5. The method of claim 1, wherein the animal is a cow, a sheep, a horse, a pig, a goat, a chicken, a dog, or a cat.

6. The method of claim 1, wherein the first set of identifying information includes an ear tag, a lot ID, a sex, a note, a feed performance, a lameness, a sickness, an antibiotic status, a pen movement, or any combination thereof.

7. The method of claim 1, wherein the model is a machine learning model.

8. The method of claim 8, wherein the model is trained with a set of augmented data.

9. The method of claim 8, wherein the set of augmented data includes a rotated image, a scaled image, a flipped image, a brightness adjusted image, a generative image, or any combination thereof.

10. An individual animal identification system comprising:
an image capturing device able to capture at least one digital image;
a communication channel connected to the image capturing device; and
a computer connected to the communication channel, the computer comprising at least one processor and a non-transitory computer readable memory;
wherein the image capturing device captures the at least one digital image and transmits the at least one digital image using the communication channel to the computer causing the computer to:
detect the presence of an animal face in the at least one digital image transmitted from the image capturing device;
determine and store the coordinates of a location of the detected face of an animal in the at least one digital image;
apply at least one transformation of the detected animal face in the at least one digital image creating at least one transformed digital image;
compare the at least one transformed digital image to at least one stored digital image using a concurrent vector comparison to calculate a degree of similarity between the at least one transformed digital image and the at least one stored digital image;
transmit the calculated degree of similarity to the image capturing device using the communication channel;
receive feedback as to the accuracy of the calculated degree of similarity between the at least one transformed digital image and the at least one stored digital image; and
update the concurrent vector comparison calculation to improve accuracy.

11. The system of claim 10, wherein the image capturing device captures data including three-dimensional orientation of the object in the digital image.

12. The system of claim 10, wherein the image capturing device captures data including a depth of an object in the digital image.

13. The system of claim 10, wherein detecting the presence of an animal face in the at least one digital image transmitted from the image capturing device includes detecting key points in the image, including the eyes, muzzle, ears, mouth, and other known facial features of the animal.

14. The system of claim 10, wherein detecting the presence of an animal face in the at least one digital image transmitted from the image capturing device includes detecting a depth of the animal.

15. The system of claim 10, wherein the concurrent vector comparison uses vectors of values to compare multiple values in different vectors simultaneously, which may be comprised of a triplet loss technique where a reference input image is compared to a matching input image and a non-matching input image to minimize the difference between the reference input image and the matching input image and maximize the distance between reference input image and the non-matching input image.

16. The system of claim 10, wherein the at least one transformation of the detected animal face in the digital image includes at least one of cropping to eliminate non-facial data, orienting the detected animal face for standard analysis and comparison, scaling the image of the detected animal face to standard size, detecting standard facial features such as distance between eyes, and deriving at least one vector of image data from the detected animal face.

17. The system of claim 10, wherein the at least one digital image may be a series of digital images comprising a video image.

18. The system of claim 10, wherein the concurrent vector comparison utilizes a comparison algorithm calculating the difference between different animal faces and using that difference calculation can select a stored image similar to the at least one transmitted image or indicate no similar image exists in non-transitory memory.
